(19) United States
(12) Patent Application Publication
(10) Pub. No.: US 2023/0076032 A1
(43) Pub. Date: Mar. 9, 2023

(54) Filter Disc for a Beverage Pod

(71) Applicant: Silgan Specialty Packaging LLC, Mequon, WI (US)

(72) Inventors: Terrence M. Parve, Menomonee Falls, WI (US); Travis Groves, Mequon, WI (US)

(21) Appl. No.: 18/046,206

(22) Filed: Oct. 13, 2022

Related U.S. Application Data
(63) Continuation of application No. 16/407,611, filed on May 9, 2019.
Application No. 16/407,611 is a continuation-in-part of application No. 16/216,337, filed on Dec. 11, 2018.

(51) Int. Cl. B65D 85/804; A47J 31/44; B01D 29/01; B01D 29/05; B01D 35/02

(52) U.S. Cl. CPC B65D 85/8043; A47J 31/446; B01D 29/014; B01D 29/05; B01D 35/02; B65D 85/8061

(57) ABSTRACT

A pod assembly for use in a beverage machine is provided. The pod assembly includes a container and a filter disc that is detachably coupled to the container. The container includes a base, a side wall having a lower rim coupling the side wall to an outer perimeter of the base, and a flange coupled to an upper rim of the side wall and extending radially outward from the upper rim. The filter disc includes a central portion with multiple central openings, an inclined portion with multiple secondary openings, and an outer flange situated at a perimeter of the inclined portion and having a substantially square shape.

### CROSS REFERENCE TO RELATED PATENT APPLICATION

The present application is a continuation of U.S. application Ser. No. 16/407,611, filed May 9, 2019, which is a continuation-in-part of U.S. patent application Ser. No. 16/216,337, filed Dec. 11, 2018, the entire disclosure of which is incorporated by reference herein.

### BACKGROUND

The present disclosure relates generally to injection molded beverage pod assemblies and more particularly to an injection molded filter disc for a beverage pod assembly. Beverage pod assemblies may be utilized in beverage machines to make a variety of beverages including coffee, tea, and hot chocolate. In use, the beverage pod assembly may be inserted into the beverage machine, and the beverage machine may introduce a fluid such as milk or water by puncturing one or more surfaces of the beverage pod and permitting the fluid to pass through the pod before exiting the machine as a prepared beverage. The beverage pod assembly may include an internal filter component to prevent certain unpalatable beverage materials (e.g., coffee grounds, tea leaves) from exiting the pod and entering the prepared beverage. A filter component optimized for shipment and easy assembly into the beverage pod would therefore be useful.

### SUMMARY

One implementation of the present disclosure is a pod assembly for use in a beverage machine. The pod assembly includes a container and a filter disc that is detachably coupled to the container. The container includes a base, a side wall having a lower rim coupling the side wall to an outer perimeter of the base, and a flange coupled to an upper rim of the side wall and extending radially outward from the upper rim. The filter disc includes a central portion with multiple central openings, an inclined portion with multiple secondary openings, and an outer flange situated at a perimeter of the inclined portion and having a substantially square shape.

Another implementation of the present disclosure is a filter disc for use in a beverage pod assembly. The filter disc includes a central portion with multiple central openings, an inclined portion with multiple secondary openings, and an outer flange situated at a perimeter of the inclined portion and having a substantially square shape.

Yet another implementation of the present disclosure is a method of providing a pod assembly for use in a beverage machine. The method includes providing a container. The container includes a base, a side wall having a lower rim coupling the side wall to an outer perimeter of the base, and a flange coupled to an upper rim of the side wall and extending radially outward from the upper rim. The method further includes providing a filter disc. The filter disc includes a central portion with multiple central openings, an inclined portion with multiple secondary openings, an outer flange situated at a perimeter of the inclined portion and having a substantially square shape, and multiple chamfered surfaces. The method further includes detachably coupling the filter disc to the container using a snap fit assembly process.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

FIG. 1 is a top perspective view of a beverage pod assembly according to an exemplary embodiment.

FIG. 2 is a bottom perspective view of the beverage pod assembly of FIG. 1, according to an exemplary embodiment.

FIG. 3 is a side elevation view of the beverage pod assembly of FIG. 1, according to an exemplary embodiment.

FIG. 4 is a side cross-sectional view of the beverage pod assembly of FIG. 1 taken along the line A-A in FIG. 3, according to an exemplary embodiment.

FIG. 5 is a detail cross-sectional view of beverage pod assembly of FIG. 1, according to an exemplary embodiment.

FIG. 6 is a top elevation view of the filter disc used in the beverage pod assembly of FIG. 1, according to an exemplary embodiment.

FIG. 7 is a side cross-sectional view of multiple filter discs in a stacked configuration, according to an exemplary embodiment.

FIG. 8 is a side cross-sectional view of multiple beverage pod assemblies in a stacked configuration, according to an exemplary embodiment.

FIG. 9 is a side detail cross-sectional view of multiple beverage pod assemblies in the stacked configuration of FIG. 8, according to an exemplary embodiment.

FIG. 10 is a top elevation view of another filter disc used in the beverage pod assembly of FIG. 1, according to an exemplary embodiment,

FIG. 11 is a side elevation view of filter disc of FIG. 10, according to an exemplary embodiment.

FIG. 12 is a side cross-sectional view of the filter disc taken along the line B-B in FIG. 10, according to an exemplary embodiment.

FIG. 13 is a side cross-sectional view of the filter disc taken along the line C-C in FIG. 10, according to an exemplary embodiment.

### DETAILED DESCRIPTION

Before discussing further details of the filter disc and the beverage pod assembly and the components thereof, it should be noted that references to “front,” “back,” “rear,” “upper,” “lower,” “inner,” “outer,” “right,” and “left,” and other directions in this description are merely used to identify the various elements as they are oriented in the FIGURES. These terms are not meant to limit the element which they describe, as the various elements may be oriented differently in various applications. Additionally, any dimensions or sizes specified for the filter disc for the beverage pod assembly and/or the components thereof should be interpreted as describing an exemplary embodiment and should not be regarded as limiting. The filter disc and the beverage pod assembly can have any of a variety of shapes and/or sizes in various applications.

### Beverage Pod Structure

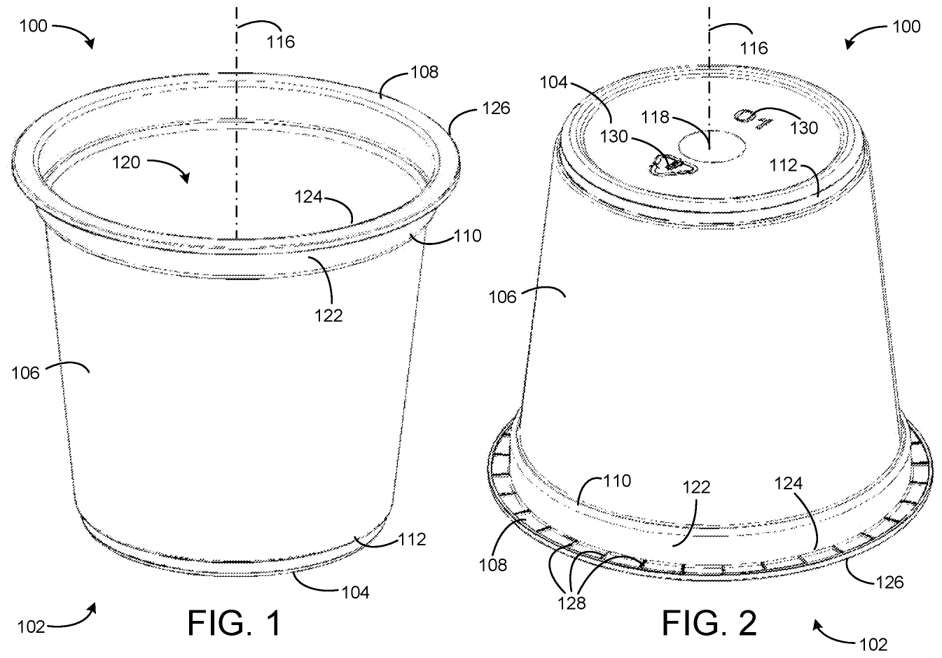

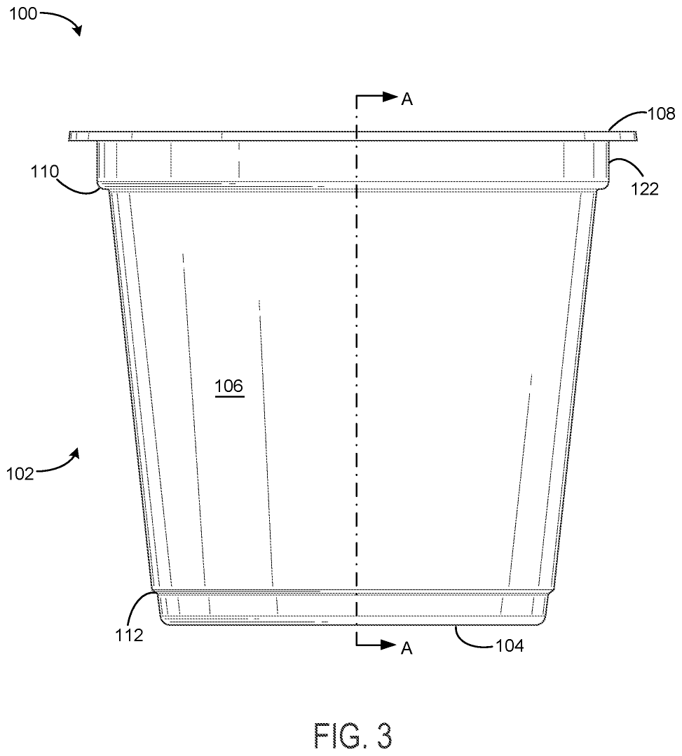

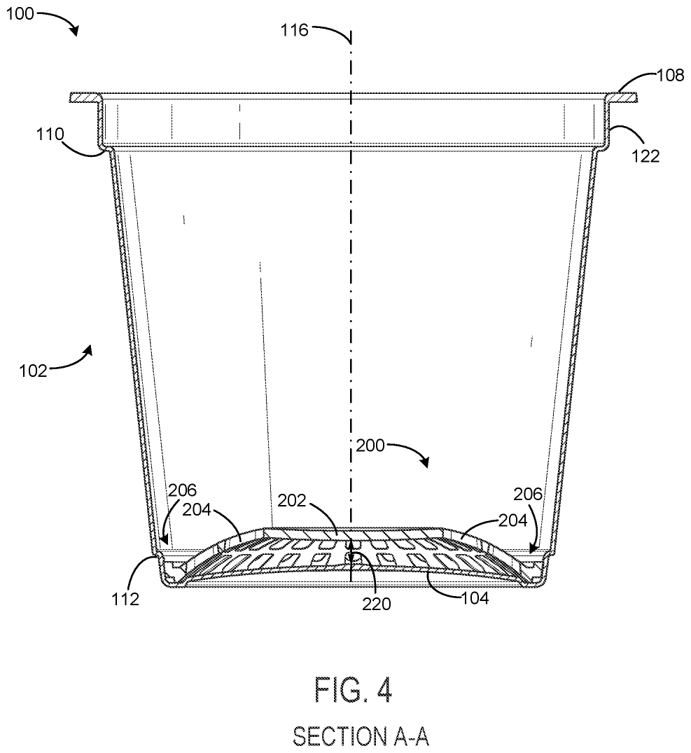

Referring now to FIGS. 1-4, a beverage pod assembly 100 is depicted, according to an exemplary embodiment. In brief overview, FIG. 1 is a top perspective view of beverage pod assembly 100, FIG. 2 is a bottom perspective view of beverage pod assembly 100, FIG. 3 is a side elevation view of beverage pod assembly 100, and FIG. 4 is a side cross-sectional view of beverage pod assembly 100 taken along the line A-A in FIG. 4.

Beverage pod assembly 100 is shown to include a container 102 with a base 104, a side wall 106, a flange 108, an upper shoulder 110 located at an upper rim of side wall 106, a lower shoulder 112 located at a lower rim of side wall 106, and a neck 122 connecting upper shoulder 110 to flange 108. In some embodiments, the container 102 is rotationally symmetric about a central axis 116 that passes through a center point 118 of base 104. Center point 118 may also be the location of the gate at which the polymeric materials are injected into the mold cavity. Container 102 may be generally cup-shaped or U-shaped, having an open end 120 opposite base 104 and an open internal volume bounded by at least base 104, side wall 106, and neck 122. However, container 102 can have a variety of shapes (e.g., rectangular, cylindrical, frustoconical) without departing from the teachings of the present disclosure. The shape of the container 102 may be defined by the shape of the mold cavity used to form container 102.

Base 104 forms the lower surface of container 102. In some embodiments, base 104 is substantially circular and extends radially outward from center point 118. Base 104 can be planar or curved in various embodiments. For example, FIG. 2 shows base 104 having a concave shape when viewed from the outside of container 102 (i.e., curving inward toward the inside of container 102). In some embodiments, base 104 includes lettering or symbols 130 (e.g., a recycling symbol) visible on the outside surface of base 104. The lettering or symbols 130 can be part of the mold cavity used to form container 102 (e.g., an embossment) or can be added to container 102 after molding (e.g., via laser etching).

In some embodiments, base 104 has a diameter between 1 inch and 1.5 inches. According to an exemplary embodiment, the diameter of base 104 is approximately 1.35 inches. In some embodiments, base 104 has a thickness between 0.01 inches and 0.02 inches. According to an exemplary embodiment, the thickness of base 104 is approximately 0.015 inches. The outer perimeter of base 104 may connect to lower shoulder 112, which connects base 104 to side wall 106. Advantageously, lower shoulder 112 provides structural support for container 102 to allow force to be applied to base 104 without crushing container 102. For example, a piercing force may be applied to the outside surface of base 104 to pierce a hole through base 104 when beverage pod assembly 100 is used. The structural support provided by lower shoulder 112 prevents container 102 from being crushed when the piercing force is applied.

Side wall 106 forms some or all of the side surface of container 102. In some embodiments, side wall 106 is substantially frustoconical, extending upward and radially outward from lower shoulder 112. In other embodiments, side wall 106 is substantially cylindrical (i.e., forming the circumferential surface of a cylinder). Side wall 106 may be angled relative to central axis 116 by an angle ranging from 0° to 10°. In some embodiments, side wall 106 is angled relative to central axis 116 by approximately 6°. The lower of side wall 106 may connect to lower shoulder 112, which connects side wall 106 to base 104. The upper rim of side wall 106 may connect to upper shoulder 110, which connects side wall 106 to neck 122.

In some embodiments, side wall 106 has a thickness between 0.01 inches and 0.02 inches. According to an exemplary embodiment, the thickness of side wall 106 is approximately 0.015 inches. In some embodiments, the lower diameter of side wall 106 (i.e., the diameter at lower shoulder 112) is between 1 inch and 1.5 inches. According to an exemplary embodiment, the lower diameter of side wall 106 is approximately 1.35 inches. In some embodiments, the upper diameter of side wall 106 (i.e., the diameter at upper shoulder 110) may be between 1.5 inches and 2.0 inches. According to an exemplary embodiment, the upper diameter of side wall 106 is approximately 1.7 inches. In some embodiments, the height of side wall 106 may be between 1.5 and 2.0 inches. According to an exemplary embodiment, the height of side wall 106 is approximately 1.74 inches.

Neck 122 may form a portion of the side surface of container 102. In some embodiments, neck 122 is substantially cylindrical, extending upward from upper shoulder 110. In some embodiments, the diameter of neck 122 is between 1.5 inches and 2.0 inches. According to an exemplary embodiment, the diameter of neck 122 is approximately 1.8 inches. In some embodiments, neck 122 has a thickness between 0.01 inches and 0.02 inches. According to an exemplary embodiment, the thickness of neck 122 is approximately 0.015 inches. In some embodiments, the height of neck 122 is between 0.1 inches and 0.3 inches. According to an exemplary embodiment, the height of neck 122 is approximately 0.2 inches. Neck 122 may contact upper shoulder 110 to an inner rim 124 of flange 108.

Flange 108 may form the upper surface of the container 102. In some embodiments, flange 108 is substantially annular (i.e., ring-shaped) extending radially outward from inner rim 124 to an outer rim 126. A cover, lid, or other closure can be sealed to container 102 along flange 108 to cover open end 120 of container 102. In some embodiments, the diameter of inner rim 124 is between 1.5 inches and 2.0 inches. According to an exemplary embodiment, the diameter of inner rim 124 is approximately 1.8 inches. In some embodiments, the diameter of outer rim 126 is between 1.75 inches and 2.25 inches. According to an exemplary embodiment, the diameter of outer rim 126 is approximately 2.0 inches. As such, the distance between inner rim 124 and outer rim 126 (i.e., the radial distance of flange 108) may be approximately 0.20 inches.

Referring specifically to FIG. 2, in some embodiments, container 102 includes a plurality of reinforcing ribs 128 on the lower surface of flange 108. Ribs 128 may extend radially outward from inner rim 124 to outer rim 126. In some embodiments, ribs 128 include between 10 and 50 radial ribs spaced equally or non-equally along the lower surface of flange 108. In some embodiments, ribs 128 include approximately 32 radial ribs. However, it is contemplated that flange 108 may include any number of ribs 128 or any other support structure (e.g., waves, etc.) depending on the geometry and size of flange 108. In some embodiments, flange 108 does not include any ribs 128.

### Filter Disc Structure

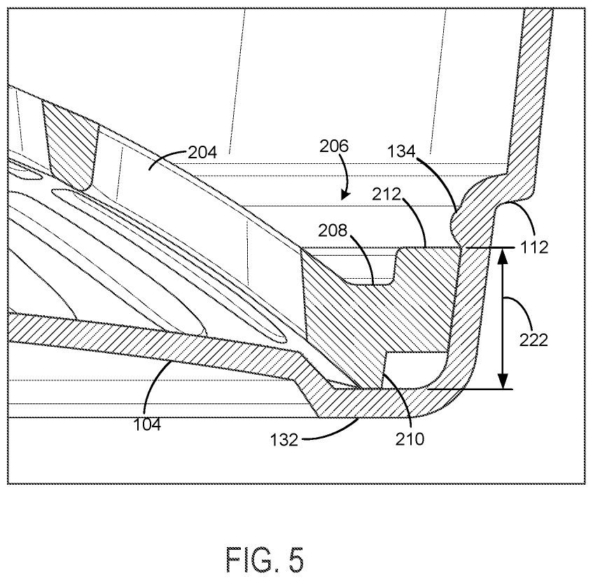

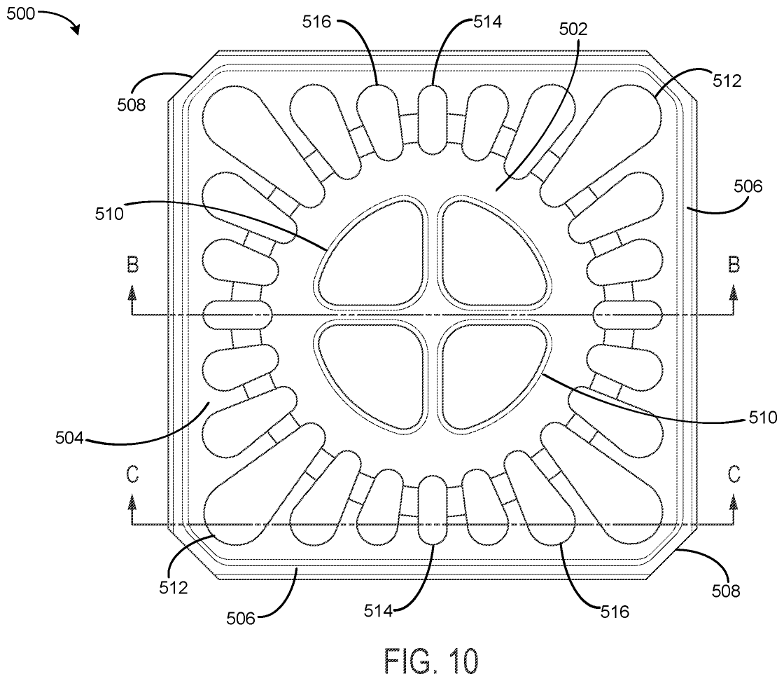

Turning now to FIGS. 4-5, the beverage pod assembly 100 is shown to include a filter disc 200 located between the base 104 and the lower shoulder 112 of the container 102. The filter disc 200 is shown to include a central portion 202, a dome-shaped portion 204, and a retention portion 206. Filter disc 200 may be fabricated as a single component using an injection molding process. As such, the central portion 202 may connect to the dome-shaped portion 204, which may connect to the retention portion 206. In an exemplary embodiment, the filter disc 200 is rotationally symmetric about the central axis 116 and has a semi-spherical shape. In other embodiments, the filter disc 200 can have a variety of shapes (e.g., rectangular, cylindrical, frustoconical) without departing from the teachings of the present disclosure. For example, a filter disc having a substantially square perimeter is depicted in FIGS. 10-13.

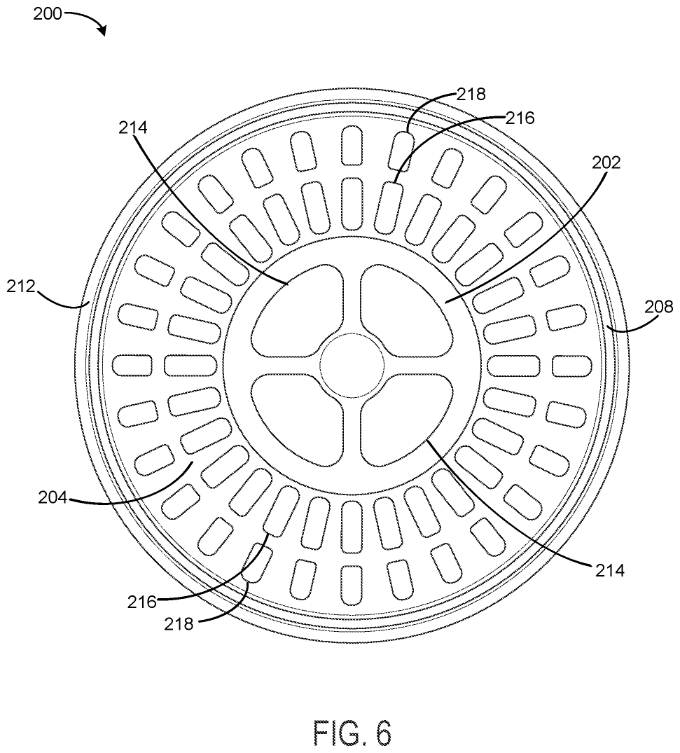

The central portion 202 of the filter disc 200 may be substantially planar or flat and may include multiple openings (described in further detail below with reference to FIG. 6). In some embodiments, the distance 220 between the central portion 202 of the filter disc 200 and the center point 118 of the container 102 is between 0.065 inches and 0.095 inches. According to an exemplary embodiment, the distance 220 between the central portion 202 and the center point 118 is approximately 0.079 inches. In various embodiments, the distance between the central portion 202 and the center point 118 may vary according to the beverage material to be included in the beverage pod 100, or the dimensions of the beverage machine in which the beverage pod 100 will be inserted. For example, if the beverage machine includes a relatively longer piercing needle utilized to pierce base 104 and permit drainage of fluid from the beverage pod 100, the distance between the central portion 202 and the center point 118 may be increased in order to avoid puncture of the filter disc 200.

The dome-shaped portion 204 may extend radially outward from the central portion 202 and may have a substantially curved (i.e., semi-spherical) shape. Similar to the central portion 202, the dome-shaped portion 204 may include multiple openings (described in further detail below with reference to FIG. 6).

Referring now specifically to FIG. 5, the retention portion 206 of the filter disc 200 is shown to include annular portion 208, foot portion 210, and retention flange 212. Annular portion 208 may extend radially outward from the dome-shaped portion 204 and may form a continuous surface surrounding the dome-shaped portion 204. In some embodiments, annular portion 208 may be substantially parallel to the central portion 202.

Foot portion 210 is shown to extend vertically from the annular portion 208. In some embodiments, the foot portion 210 may form a continuous surface with the dome-shaped portion 204. When filter disc 200 is in an installed configuration within the container 102, foot portion 210 may contact a filter disc locating wall 132 extending radially outward from base 104. Retention flange 212 is shown to extend vertically from annular portion 208 in a direction opposite and radially outward from the foot portion 210. In some embodiments, retention flange 212 forms a continuous ring extending from the annular portion 208. In other embodiments, retention flange 212 may include multiple segments distributed about the annular portion 208.

The retention flange 212 may permit the filter disc 200 to be retained between the base 104 and the lower shoulder 112 using a snap fit assembly process. For example, in some embodiments, container 102 includes a locating protrusion 134 situated opposite the lower shoulder 112. In an exemplary embodiment, locating protrusion 134 may form a continuous ring about the interior of container 102. In other embodiments, locating protrusion 134 may include multiple segments distributed about the interior of container 102. Locating protrusion 134 may serve as a positive stop for retention flange 212 as the filter disc 200 is inserted into the container 102 towards the base 104. For example, passage of the retention flange 212 over the locating protrusion 134 may result in an audible snapping sound, indicating that the filter disc 200 has been successfully installed within the container 102. The distance between the filter disc locating wall 132 and the locating protrusion 134 may be controlled such that vertical movement of the filter disc 200 is constrained once the filter disc 200 is installed within the container 102. In some embodiments, the distance 222 between the filter disc locating wall 132 and the locating protrusion 134 is between 0.060 inches and 0.080 inches. According to an exemplary embodiment, the distance between the filter disc locating wall 132 and the locating protrusion 134 is approximately 0.075 inches.

Referring now to FIG. 6, a top view of the filter disc 200 is depicted, according to an exemplary embodiment. As described above, filter disc 200 is shown to include multiple openings that permit the passage of a fluid (e.g., water, milk) through the beverage pod assembly 100 and out of a beverage machine. The multiple openings may include central filter openings 214 and secondary filter openings 216 and 218. In some embodiments, central filter openings 214 comprise four openings situated in a radial pattern about the central portion 202 of filter disc 200. In an exemplary embodiment, central filter openings 214 have a rounded semi-trapezoidal shape. In other embodiments, central filter openings 214 may have any size, shape, or pattern required to achieve a desired beverage strength and to prevent unpalatable beverage materials (e.g., coffee grounds, tea leaves) from entering the prepared beverage as it exits the beverage machine.

In some embodiments, secondary filter openings 216 and 218 are arranged in a uniform radial pattern of two rows surrounding the central filter openings 214. As shown, each of the secondary filter openings 216 and 218 may be substantially smaller than the central filter openings 214. In an exemplary embodiment, secondary filter openings 216 and 218 each include twenty-eight openings arranged in a radial pattern, with each opening having a rounded slot shape. In other embodiments, secondary filter openings 216 and 218 may have any size, shape, or pattern required to achieve a desired beverage strength and to prevent unpalatable beverage materials from entering the prepared beverage.

The outer diameter of filter disc 200 (i.e., the diameter at the outermost edge of the retention flange 212) may range between 1 inch and 1.5 inches. According to an exemplary embodiment, the outer diameter of filter disc 200 is approximately 1.3 inches. In some embodiments, the central portion 202 and the dome-shaped portion 204 has a substantially uniform nominal thickness. For example, each of the central portion 202 and the dome-shaped portion 204 may have a thickness between 0.020 and 0.050 inches. According to an exemplary embodiment, the thickness of central portion 202 and the dome shaped-portion 204 is approximately 0.035 inches.

In some embodiments, filter disc 200 is made of recyclable material and/or a compostable material. A compostable material can be defined as a plastic or other material designed to be composted under aerobic conditions in municipal and/or industrial aerobic composting facilities, where thermophilic conditions are achieved. For example, filter disc 200 may be made of a compostable material that satisfied the ASTM D6400 standard specification for compostable materials. In some embodiments, filter disc 200 may be made of a biodegradable material. Some materials may be both compostable and biodegradable. In various embodiments, filter disc 200 may be fabricated using an injection molding process from the same material as the container 102 (e.g., polyethylene (PE), polyethylene terephthalate (PET), polylactic acid (PLA), polypropylene (PP)). In other embodiments, filter disc 200 and container 102 may be fabricated from different materials.

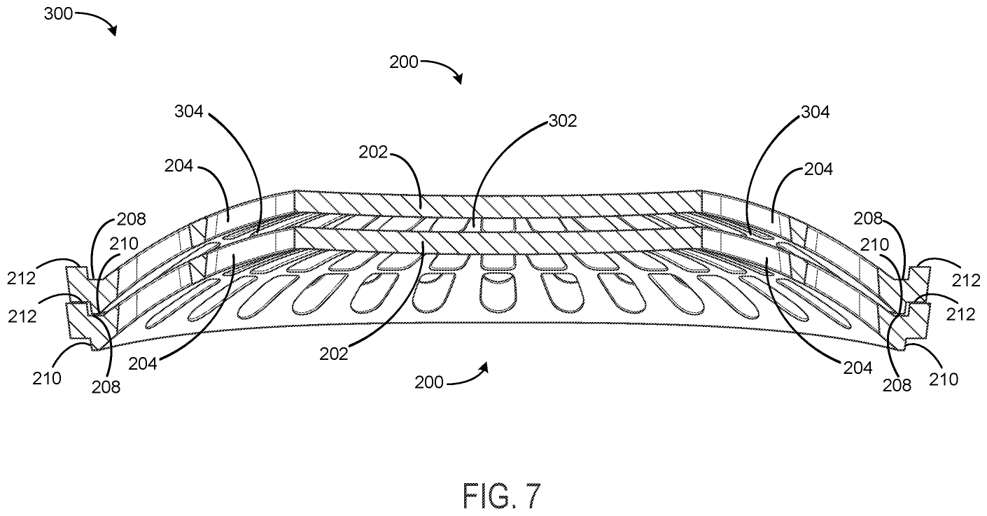

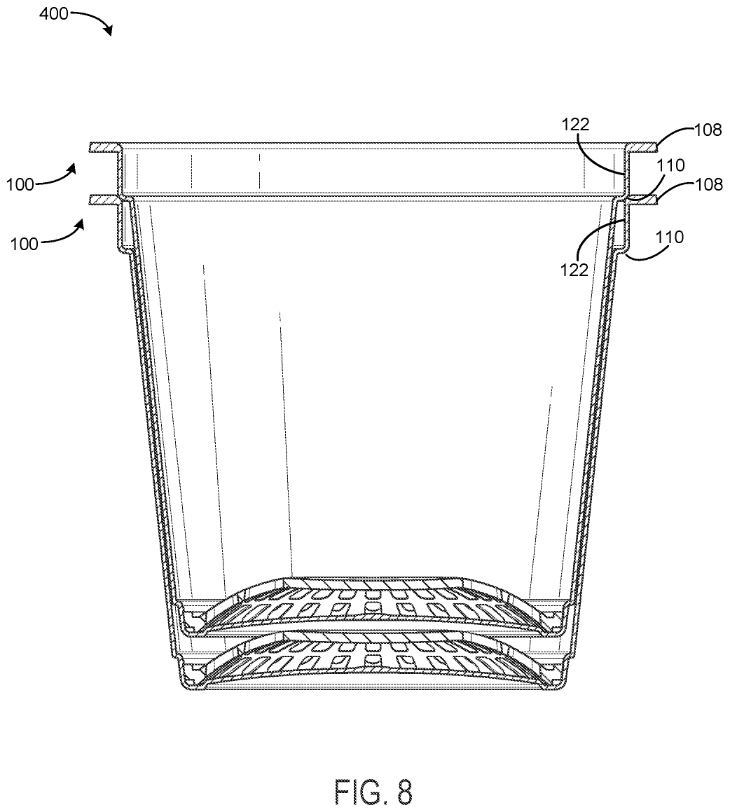

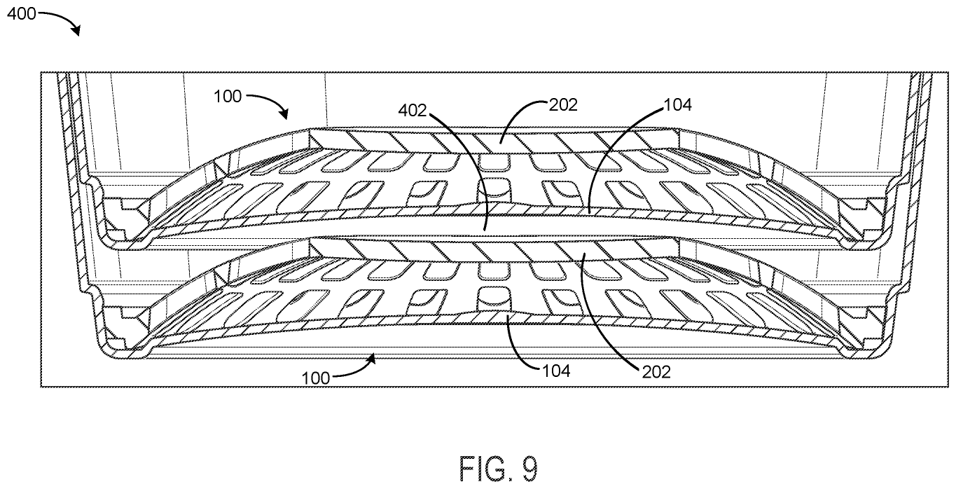

Referring now to FIG. 7-9, cross-sectional views of multiple filter discs 200 and beverage pod assemblies 100 in stacked configurations are depicted, according to an exemplary embodiment. In brief overview, FIG. 7 depicts a side cross-sectional view of a stacked configuration 300 of multiple filter discs 200, FIG. 8 depicts a side cross-sectional view of a stacked configuration 400 of multiple beverage pods 100, and FIG. 9 depicts a detail side cross-sectional view of stacked configuration 400.

FIG. 7 depicts a stacked configuration 300 of multiple filter discs 200. Multiple filter discs 200 may be arranged in the stacked configuration 300 before each filter disc 200 is inserted within a container 102 to form a beverage pod assembly 100. For example, multiple filter discs 200 may be arranged in the stacked configuration 300 during a shipping or storage process. Although FIG. 7 depicts two filter discs 200 in the stacked configuration 300, stacked configuration 300 may be utilized for any number of filter discs 200.

As shown, the annular portion 208 of the lower filter disc 200 is configured to receive the foot portion 210 of the upper filter disc 200. Similarly, the retention flange 212 of upper filter disc 200 is configured to nest atop the retention flange 212 of the lower filter disc 200. Stacked configuration 300 is further shown to include a clearance region 302 between the central portions 202 of the upper and lower filter discs 200, as well as a clearance region 304 between the dome-shaped portions 204 of the upper and lower filter discs 200. By maintaining clearance regions 302 and 304 between the filter discs 200, the discs are easily separable from the stacked configuration 300. At the same time, since the clearance regions 302 and 304 are minimal (e.g., ranging between approximately 0.005 and 0.025 inches), each of the filter discs 200 in the stacked configuration 300 is protected from structural deformation due to a crushing force, and the overall stack height of the stacked configuration 300 is minimized.

Turning now to FIGS. 8-9, cross-sectional views of a stacked configuration 400 of multiple beverage pods 100 are depicted, according to an exemplary embodiment. Multiple beverage pods 100 may be arranged in the stacked configuration 400 before each beverage pod assembly 100 is filled with beverage material and sealed with a cover attached to flange 108. For example, multiple beverage pods 100 may be arranged in the stacked configuration 400 during a shipping or storage process. Although stacked FIGS. 8 and 9 depict two beverage pod assemblies 100 in the stacked configuration 400, stacked configuration 400 can be utilized for any number of beverage pod assemblies 100.

As depicted specifically in FIG. 8, the upper shoulder 110 of an upper beverage pod assembly 100 is configured to nest atop flange 108 of a lower beverage pod assembly 100. In this way, each beverage pod assembly 100 in the stacked configuration 400 is separated by approximately the length of the neck 122. In various embodiments, the length of neck 122 may range from 0.1 inches to 0.3 inches. According to an exemplary embodiment, the length of neck 122 is approximately 0.2 inches. As depicted specifically in FIG. 9, this separation ensures the maintenance of a clearance region 402 between the central portion 202 of a lower beverage pod assembly 100 and the base 104 of an upper beverage pod assembly 100. Advantageously, the clearance region 402 prevents the deformation of filter disc 200 within container 102, while at the same time minimizing the stack height of stacked configuration 400.

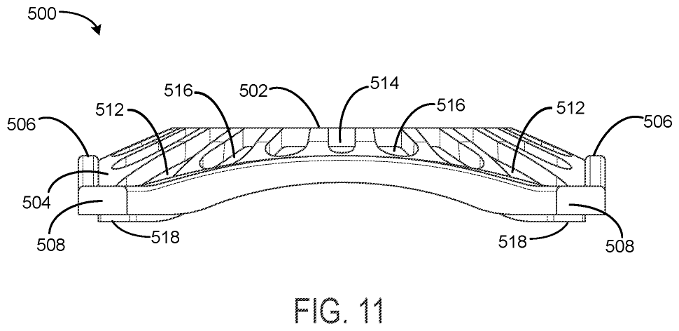

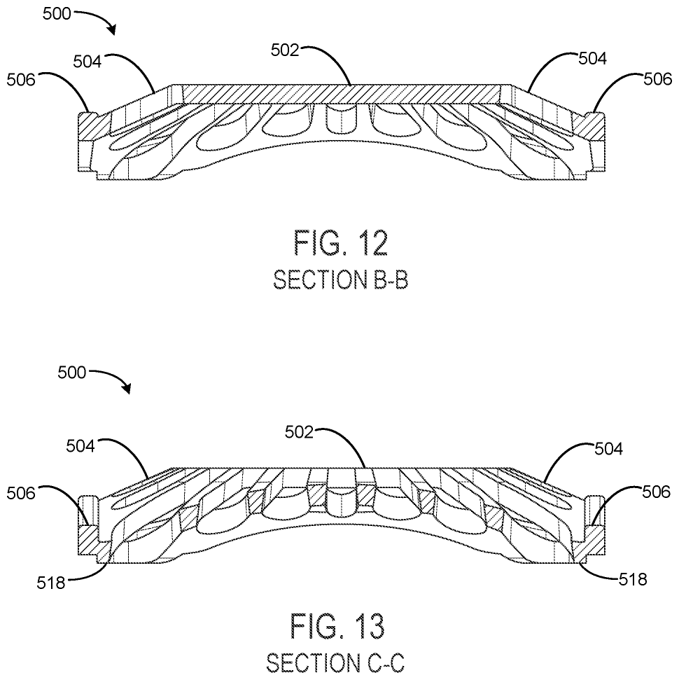

Referring now to FIGS. 10-13, an alternative embodiment filter disc 500 is depicted. Specifically, FIG. 10 depicts a top view of filter disc 500, FIG. 11 depicts a side view, and FIGS. 12 and 13 depict side cross-sectional views taken about the lines B-B and C-C of FIG. 10 respectively. In contrast to the filter disc 200 depicted in FIGS. 3-9, the filter disc 500 may have a rectangular or substantially rectangular perimeter, depicted here in FIGS. 10-13 as having a substantially square outer perimeter. The rectangular or square perimeter may permit the filter disc 500 to utilize less material than the filter disc 200. The rectangular or square perimeter may also aid in filter sizing and fluid flow. The rectangular or square perimeter filter disc 500 may be assembled to a container 102 using a snap fit assembly process in substantially the same way that the filter disc 200 is assembled to the container 102.

The filter disc 500 is shown to include a central portion 502, an inclined portion 504, and an outer flange 506 located along a perimeter of the inclined portion 504. Filter disc 500 may be fabricated as a single component using an injection molding process. As such, the central portion 502 may connect to the inclined portion 504, which may connect to the outer flange 506. In an exemplary embodiment, the filter disc 500 is rotationally symmetric about a central axis (not shown) extending perpendicularly from the center point of the central portion 502. The square perimeter of the retention flange 506 may be interrupted by chamfered surfaces 508 situated at the corners of the filter disc 500. In some embodiments, the chamfered surfaces 508 may be oriented at 45° angles relative to the square sides of the retention flange 506. In other embodiments, the chamfered surfaces 508 may be oriented at a different angle.

The central portion 502 of the filter disc 500 may be substantially planar or flat and may include central filter openings 510. The inclined portion 504 may extend radially outward from the central portion 502. Secondary filter openings 512-516 may be situated predominately in the inclined portion 504 and may extend partially into the central portion 502. Openings 510-516 may permit the passage of a fluid (e.g., water, milk) through the beverage pod assembly 100 and out of a beverage machine. In some embodiments, the central filter openings 510 comprise four openings arranged in a radial pattern about the central portion 502 of filter disc 500. In an exemplary embodiment, central filter openings 510 have a rounded triangular shape. In other embodiments, central filter openings 510 may have any desired size, shape, or pattern.

In some embodiments, secondary filter openings 512-516 are arranged in a radial pattern surrounding the central filter openings 510. The size of the secondary filter openings 512-516 may vary based on the radial position of the opening. For example, the openings 512 located in the corners of the filter disc 500 proximate the chamfered surfaces 508 may be the largest secondary openings, and may have a rounded teardrop shape. The openings 514 located at the midpoint between openings 512 may be the smallest secondary openings, and may have an elongated slot or oval shape. The openings 516 located between the openings 512 and the openings 514 may have an intermediate size (i.e., smaller than openings 512 and larger than openings 514), and may have a rounded teardrop or elongated slot shape. In other embodiments, secondary filter openings 512-515 may have any desired size, shape, or pattern.

The outer width and length of the filter disc 500 (i.e., the width and length at the outermost edges of the outer flange 506) may range between 1 inch and 1.5 inches. In some embodiments, the central portion 502 and the inclined portion 504 has a substantially uniform nominal thickness. For example, each of the central portion 502 and the inclined portion 504 may have a thickness between 0.020 and 0.050 inches. In some embodiments, the thickness of the central portion 502 and the inclined portion 504 is approximately 0.035 inches. In other embodiments, the inclined portion 504 is 30-40% thinner than the central portion 502.

Referring specifically to FIGS. 11 and 13, multiple foot portions 518 are shown to extend below the outer flange 506 proximate the chamfered surfaces 508. In some embodiments, the thickness of each foot portion 518 (i.e., the amount that the foot portion 518 extends below the outer flange 506) may vary. The foot portion 518 and the outer flange 506 may be utilized to retain the filter disc 500 within the container 102. For example, similar to the arrangement depicted in FIG. 5, the foot portion 518 and the outer flange 506 may be configured to fit between the filter disc locating wall 132 and the locating protrusion 134 of the container 102. In some embodiments, the filter disc 500 contacts the container 102 at four discrete regions proximate the chamfered surfaces 508 (i.e., the filter disc 500 does not contact the container 102 along the entire perimeter of the outer flange 506).

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

In the present disclosure, the word “exemplary” is used to mean serving as an example, instance, or illustration. Any embodiment or design described herein as “exemplary” is not necessarily to be construed as preferred or advantageous over other embodiments or designs. Rather, use of the word “exemplary” is intended to present concepts in a concrete manner. Accordingly, all such modifications are intended to be included within the scope of the present disclosure.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

As used herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A pod assembly for use in a beverage machine, the pod assembly comprising:
a container comprising:
a base;
a side wall having a lower rim coupling the side wall to an outer perimeter of the base; and
a flange coupled to an upper rim of the side wall and extending radially outward from the upper rim;
a filter disc detachably coupled to the container and comprising:
a central portion comprising a plurality of central openings;
an inclined portion comprising a plurality of secondary openings; and
an outer flange situated at a perimeter of the inclined portion and having a substantially square shape;
wherein the plurality of central openings and the plurality of secondary openings are each configured to permit the passage of fluid through the filter disc of the pod assembly and to prevent the passage of solid beverage materials from entering the prepared beverage.

2. The pod assembly of claim 1, wherein the container further comprises a locating protrusion disposed on an interior surface of the side wall.

3. The pod assembly of claim 2, wherein the locating protrusion is configured to retain the filter disc between the base and the lower rim.

4. The pod assembly of claim 1, wherein the filter disc is detachably coupled to the container using a snap fit assembly process.

5. The pod assembly of claim 1, wherein the filter disc further comprises a plurality of chamfered surfaces.

6. The pod assembly of claim 5, wherein the filter disc is configured to detachably couple to the container at a plurality of discrete regions proximate the plurality of chamfered surfaces.

7. The pod assembly of claim 5, wherein the plurality of secondary openings comprise a plurality of sizes.

8. The pod assembly of claim 7, wherein a first plurality of secondary openings having a greater size than the rest of the plurality of secondary openings are located proximate the plurality of chamfered surfaces.

9. The pod assembly of claim 1, wherein at least one of the container and the filter disc is fabricated using an injection molding process.

10. A filter disc for use in a beverage pod assembly, the filter disc comprising:
a central portion comprising a plurality of central openings;
an inclined portion comprising a plurality of secondary openings; and
an outer flange situated at a perimeter of the inclined portion and having a substantially square shape;
wherein the plurality of central openings and the plurality of secondary openings are each configured to permit the passage of fluid through the filter disc of the pod assembly and to prevent the passage of solid beverage materials from entering the prepared beverage.

11. The filter disc of claim 10, wherein the filter disc further comprises a plurality of chamfered surfaces.

12. The filter disc of claim 11, wherein the filter disc further comprises a plurality of foot portions extending below the outer flange and proximate the plurality of chamfered surfaces.

13. The filter disc of claim 10, wherein each of the plurality of central openings and the plurality of secondary openings is arranged in a radial pattern that is rotationally symmetric about a central axis extending perpendicularly from a center point of the central portion.

14. The filter disc of claim 10, wherein at least one of the plurality of secondary openings has an elongated slot shape.

15. The filter disc of claim 10, wherein the central portion is substantially planar.

16. The filter disc of claim 10, wherein the filter disc is fabricated using an injection molding process.

17. A method of providing a pod assembly for use in a beverage machine, the method comprising:
providing a container comprising:
a base;
a side wall having a lower rim coupling the side wall to an outer perimeter of the base; and
a flange coupled to an upper rim of the side wall and extending radially outward from the upper rim;
providing a filter disc comprising:
a central portion comprising a plurality of central openings;
an inclined portion comprising a plurality of secondary openings;
an outer flange situated at a perimeter of the inclined portion and having a substantially square shape; and
a plurality of chamfered surfaces; and
detachably coupling the filter disc to the container using a snap fit assembly process;
wherein the plurality of central openings and the plurality of secondary openings are each configured to permit the passage of fluid through the filter disc of the pod assembly and to prevent the passage of solid beverage materials from entering the prepared beverage.

18. The method of claim 17, wherein the container further comprises a locating protrusion disposed on an interior surface of the side wall.

19. The method of claim 18, wherein detachably coupling the filter disc to the container comprises sliding the filter disc over the locating protrusion toward the base.

20. The method of claim 17, wherein the filter disc is configured to detachably couple to the container at a plurality of discrete regions proximate the plurality of chamfered surfaces.
